(19) United States
(12) Patent Application Publication
(10) Pub. No.: US 2018/0244127 A1
(43) Pub. Date: Aug. 30, 2018

(54) THERMAL MANAGEMENT SYSTEM AND METHOD

(71) Applicant: General Electric Company, Schenectady, NY (US)

(72) Inventors: Mohammed El Hacin Sennoun, West Chester, OH (US); James Fitzgerald Bonar, Cincinnati, OH (US); Rachel Wyn Levine, Bamberg (DE); Nicolas Sabo, West Chester, OH (US); Jared Wolfe, West Chester, OH (US); John Dowell, Grove City, PA (US); Kevin Bailey, GROVE CITY, PA (US)

(21) Appl. No.: 15/821,729

(22) Filed: Nov. 22, 2017

Related U.S. Application Data
(63) Continuation-in-part of application No. 15/444,566, filed on Feb. 28, 2017.

(51) Int. Cl. B60H 1/00

(52) U.S. Cl. CPC B60H 1/00342

(57) ABSTRACT

A thermal management system includes a housing, and a monolithic core structure disposed within the housing. An outer surface of the core structure defines at least part of a first passageway. An inner surface of the core structure defines at least part of a second passageway. The core structure includes a separator wall that isolates a first flow passing through the first passageway from a second flow passing through the second passageway. The first passageway is in thermal communication with the second passageway. The core structure includes one or more heat exchanger features, or fins, that are positioned within the first passageway, the second passageway, or both the first and second passageways. The core structure may have a compliant segment coupled to two or more walls.

### CROSS REFERENCE TO RELATED APPLICATIONS

This application is a continuation-in-part and claims priority to U.S. patent application Ser. No. 15/444,566, filed on 28 Feb. 2017, the disclosure of which is hereby incorporated by reference in its entirety.

### FIELD

Embodiments may relate to a thermal management system and associated method.

### BACKGROUND

Thermal management systems may be designed as heat exchangers. Heat exchangers may be employed with engines for transferring heat between one or more fluids. For example, a first fluid at a relatively high temperature may pass through a first passageway, while a second fluid at a relatively low temperature may pass through a second passageway. The first and second passageways may be in thermal contact or close proximity, allowing heat from the first fluid to be passed to the second fluid. Thus, the temperature of the first fluid may be decreased and the temperature of the second fluid may be increased.

Conventional heat exchangers may include a large number of fluid passageways, each fluid passageway being formed using some combination of plates, bar, foils, fins, manifolds, etc. Each of these parts must be individually positioned, oriented, and connected to the supporting structure, e.g., via brazing, welding, or another joining method. Thus, for example, one particular heat exchanger for an engine includes 250 parts that must be assembled into a single, fluid-tight component. The manufacturing time and costs associated with the assembly of such a heat exchanger are high and the likelihood of fluid leaks between the fluid passageways or from the heat exchanger is increased due to the number of joints formed. In addition, manufacturing restrictions may constrain the number, size, and configuration of heat exchanger features that may be included in the heat exchanger, e.g., within the fluid passageways.

Accordingly, an engine with a heat exchanger that differs from those heat exchangers that are currently available may be desirable.

### BRIEF DESCRIPTION

In one embodiment of the invention, a thermal management system includes a housing. The system also includes a monolithic core structure disposed within the housing. An outer surface of the core structure defines at least part of a first passageway. An inner surface of the core structure defines at least part of a second passageway. The core structure includes a separator wall that isolates a first flow passing through the first passageway from a second flow passing through the second passageway. The first passageway is in thermal communication with the second passageway. The core structure includes one or more heat exchanger features, or fins, that are positioned within the first passageway, the second passageway, or both the first and second passageways. The heat exchanger features have a thickness and a distribution density. And, the core structure further has a compliant segment having a first end coupled to the housing structure and a second end coupled to the separator wall. In another embodiment, the compliant segment couples one separator wall to another separator wall.

In one embodiment, the thermal management system includes a housing. The system also includes a monolithic core structure within the housing. There is an outer surface of the core structure defining at least part of a first passageway and an inner surface of the core structure defining at least part of a second passageway. The core structure includes a separator wall that fluidically isolates a first flow passing through the first passageway from a second flow passing through the second passageway. The first passageway is in thermal communication with the second passageway. The core structure, includes one or more heat exchanger features that are positioned within the first passageway, the second passageway, or both the first and second passageway. The heat exchanger features have a thickness and a distribution density. Also, the core structure comprises two or more different materials that are non-homogeneous and unalloyed with each other.

In one embodiment, the thermal management system includes a housing. The system includes a monolithic core structure within the housing. There is an outer surface of the core structure defining at least part of a first passageway and an inner surface of the core structure defining at least part of a second passageway. The core structure includes a separator wall that fluidically isolates a first flow passing through the first passageway from a second flow passing through the second passageway. The first passageway is in thermal communication with the second passageway. The monolithic core structure includes one or more fins that are positioned within the first passageway, the second passageway, or both the first and second passageway. The fins have a complex shape. The monolithic core structure includes a surface layer, or a coating that is a different material than a base portion of the core structure, the one or more fins, or both the core structure and the fins.

### BRIEF DESCRIPTION OF THE DRAWINGS

A full and enabling disclosure of the invention, including the best mode thereof, directed to one of ordinary skill in the art, is set forth in the specification, which makes reference to the appended figures.

FIG. 1 provides a perspective view of a heat exchanger according to an embodiment of the subject matter.

FIG. 2 provides a perspective, cross-sectional view of the heat exchanger of FIG. 1.

FIG. 3 provides another perspective, cross-sectional view of the heat exchanger of FIG. 1.

FIG. 4 provides a close-up perspective view of a first fluid passageway of the heat exchanger of FIG. 1.

FIG. 5 provides a cross-sectional view of the heat exchanger of FIG. 1.

FIG. 6 provides a close-up, cross-sectional view of a second fluid passageway of the heat exchanger of FIG. 1.

FIG. 7 is a method for forming a heat exchanger according to an embodiment of the subject matter.

FIG. 8 provides a schematic view of a heat exchanger according to an embodiment of the subject matter.

Repeat use of reference characters in the specification and drawings is intended to re the same or analogous features or elements of the invention.

### DETAILED DESCRIPTION

A heat exchanger and a method for additively manufacturing the heat exchanger are provided. The heat exchanger includes a plurality of fluid passageways that are formed by additive manufacturing methods which enable the formation of fluid passageways that are smaller in size, that have thinner walls, and that have complex and intricate heat exchanger features. For example, the fluid passageways may be curvilinear, heat exchanging features (fins, whiskers, etc.) may be angled relative to their substrate, be less than 0.01 cm thick, and may be disposed at a density of more than twelve per centimeter. In addition, the heat exchanging fins may be angled with respect to the walls of the fluid passageways and adjacent fins may be helical, offset or staggered relative to each other.

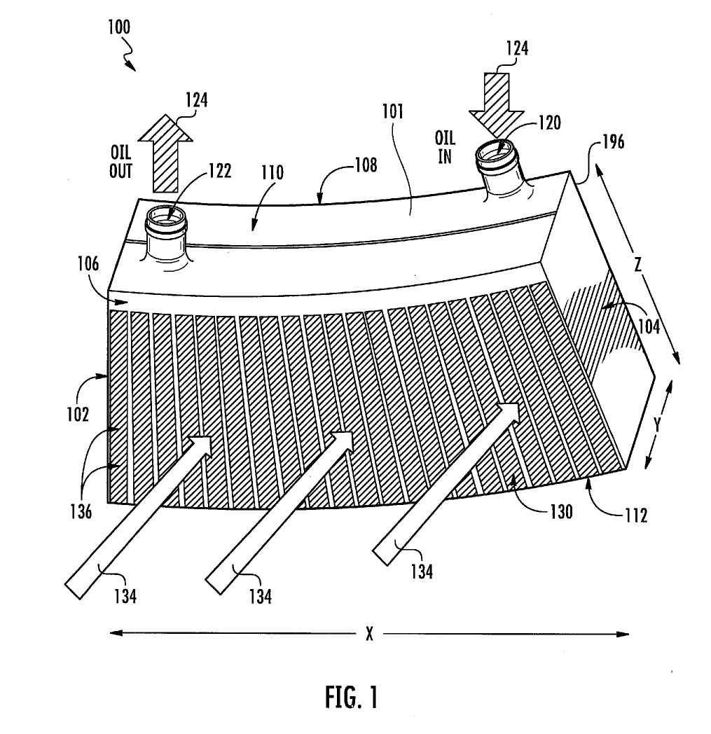

Referring to FIG. 1, a heat exchanger core structure 100 of a thermal management system is provided to describe one embodiment of the subject matter. The heat exchanger may transfer heat between two or more fluids during use. For example, the heat exchanger may transfer heat from lubricating oil to air in an engine. Different heat exchanger embodiment can receive suitable types of fluid for use in the heat transfer process. In addition, the concepts and heat exchanging structures disclosed herein similarly could be used in automotive, aviation, maritime, and other mobile and stationary industries to assist in heat transfer between fluids.

The device of FIG. 1 illustrates a thermal management system having a heat exchanger to explain its operation. The heat exchanger may include an external housing 101 that extends between a left side 102 and a right side 104 along a first direction, e.g., the X-direction. In addition, external housing 101 extends between a front side 106 and a back side 108 along a second direction, e.g., the Y-direction. The external housing also extends between a top side 110 and a bottom side 112 along a third direction, e.g., the Z-direction. The X-direction, the Y-direction, and the Z-direction are mutually perpendicular with one another, such that an orthogonal coordinate system is defined. The heat exchanger and the X-Y-Z coordinate system are used herein only for the purpose of explaining aspects of the subject matter and are not intended to limit the scope of the disclosure. In this regard, directional indicators such as “left” and “right,” “front” and “back,” and “top” and “bottom” are only used to indicate the relative positioning of two sides of heat exchanger along the X-direction, the Y-direction, and the Z-direction, respectively.

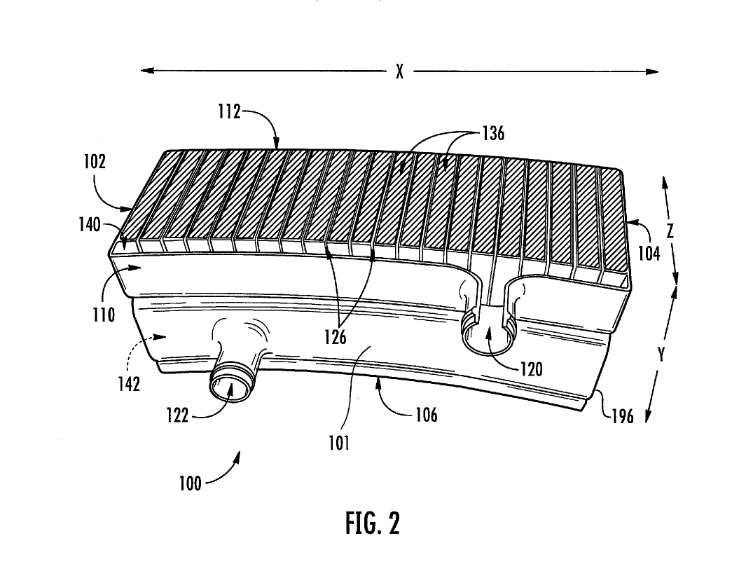

An oil inlet 120 and an oil outlet 122 are defined on the top side of the heat exchanger. In this manner, oil (as indicated by arrows 124) enters the heat exchanger through the oil inlet, passes through a plurality of first fluid passageways 126 (FIG. 2), and exits the heat exchanger through the oil outlet, as will be described in detail below. In addition, an air inlet 130 is disposed in the front side of the heat exchanger and an air outlet (not shown) is defined in the back side of the heat exchanger. Therefore, air (as indicated by arrows 134) enters the heat exchanger through the air inlet and passes through a plurality of second fluid passageways 136. First and second fluid passageways are in thermal communication with each other for transferring heat between the fluids passing therethrough. The first fluid passageways and second fluid passageways are separate from each other in that the respective fluids do not physically mix with each other. In this regard, each of first fluid passageways and second fluid passageways may be separated by a plurality of heat exchanger walls. For the illustrated embodiment, the thickness of the walls of the external housing differ along their length and are in range of from about 0.0762 cm to 0.0254 cm.

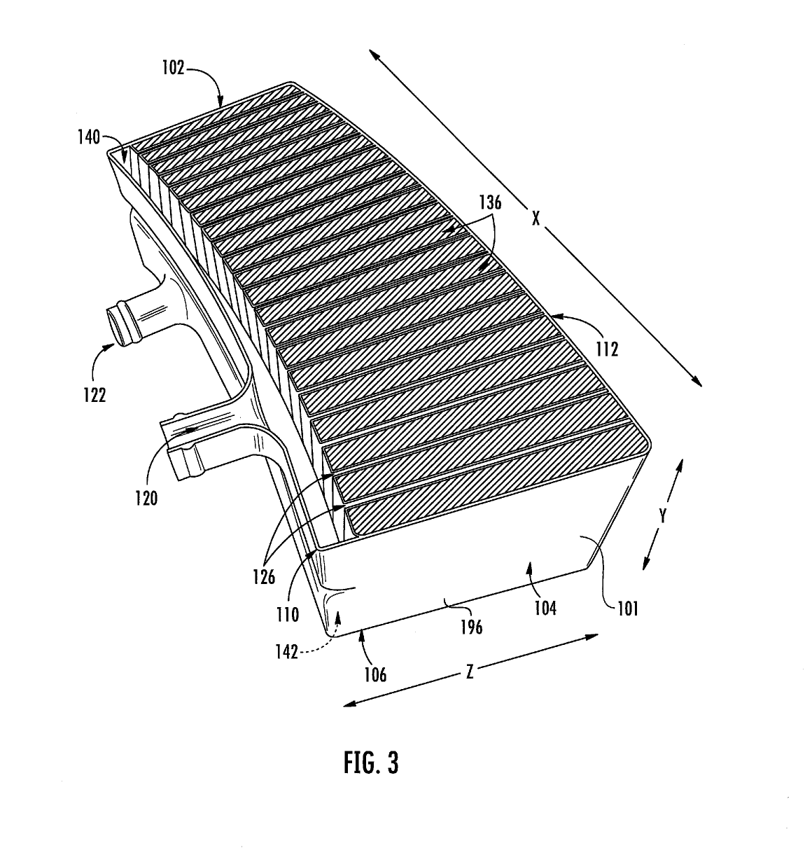

Referring to FIGS. 2 and 3, the heat exchanger defines an inlet plenum 140 and an outlet plenum 142 in direct fluid communication with the oil inlet and the oil outlet, respectively. The inlet plenum allows oil to diverge from the oil inlet and spread out to all of the plurality of the first fluid passageways. By contrast, the outlet plenum allows oil to converge from all of the plurality of the first fluid passageways into the oil outlet before exiting the heat exchanger.

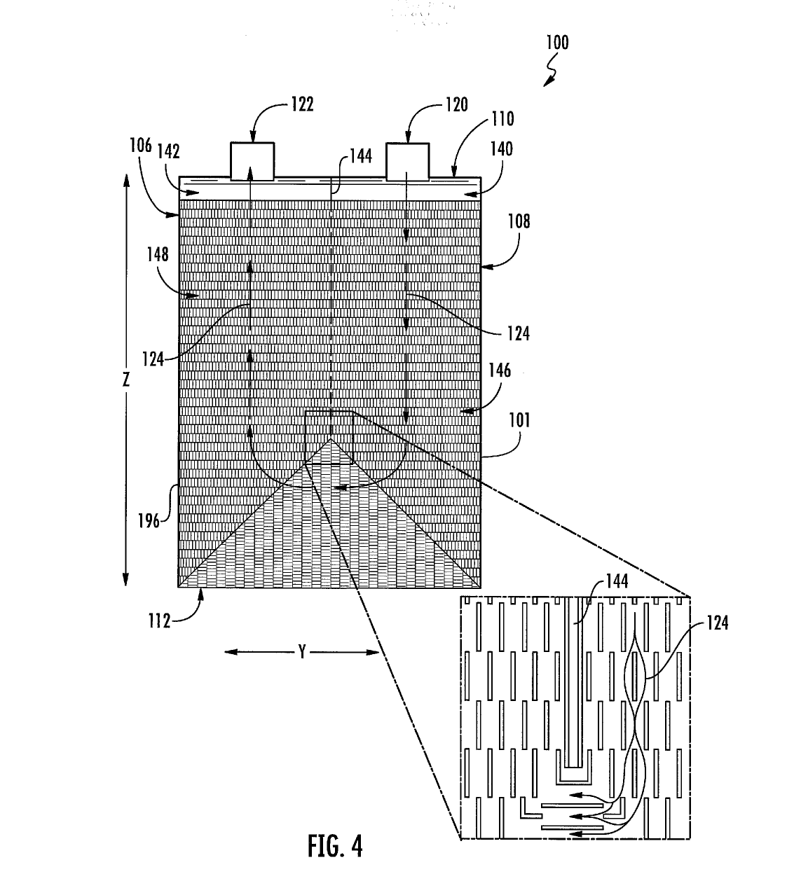

The inlet plenum and the outlet plenum are separated along the Y-direction by a divider wall 144 such that the inlet plenum and the outlet plenum are in fluid communication only through the plurality of the first fluid passageways. Referring now specifically to FIG. 4, the divider wall extends from the top side along the Z-direction toward the bottom side (without reaching the bottom side) to separate the plurality of the first fluid passageways and define an inflow segment 146 and an outflow segment 148. In this manner, as oil enters the heat exchanger through the oil inlet and the inlet plenum, the first fluid passageways generally direct the oil downward along the Z-direction in the inflow segment. The oil then passes around the divider wall and travels upward along the Z-direction in the outflow segment toward the outlet plenum. According to the embodiment, the divider wall extends from the top side along the Z-direction to a bottom half or a bottom quarter of the heat exchanger (i.e., between about fifty and seventy-five percent of a height of the heat exchanger along the Z-direction). In another embodiment, the divider wall may extend a different distance from the top side. Alternatively, each of the plurality of the first fluid passageways may be self-contained (e.g., such that the oil does not mix between adjacent passageways) and may be formed into a U-shape.

A single the divider wall is illustrated such that the first fluid passageways form a U-shape and directs oil through two passes of the heat exchanger. More specifically, oil travels substantially along an entire length of the heat exchanger downward along the Z-direction in the inflow segment and upward along the Z-direction in the outflow segment. In addition, air is illustrated as making a single pass through the heat exchanger, i.e., from the front side to the back side substantially along the Y-direction. However, it should be appreciated that the heat exchanger, and more particularly first and second fluid passageways, may direct their respective fluid through any suitable number of passes to achieve the desired fluid flow and thermal transfer characteristics. For example, the heat exchanger may include a plurality of divider walls, baffles and/or plenums that direct the oil through four our more passes through the heat exchanger. Similarly, divider walls, baffles and/or plenums in the second fluid passageway may direct air through multiple passes through the heat exchanger to increase dwell time, number of impingement opportunities, and ultimately the amount of heat transfer.

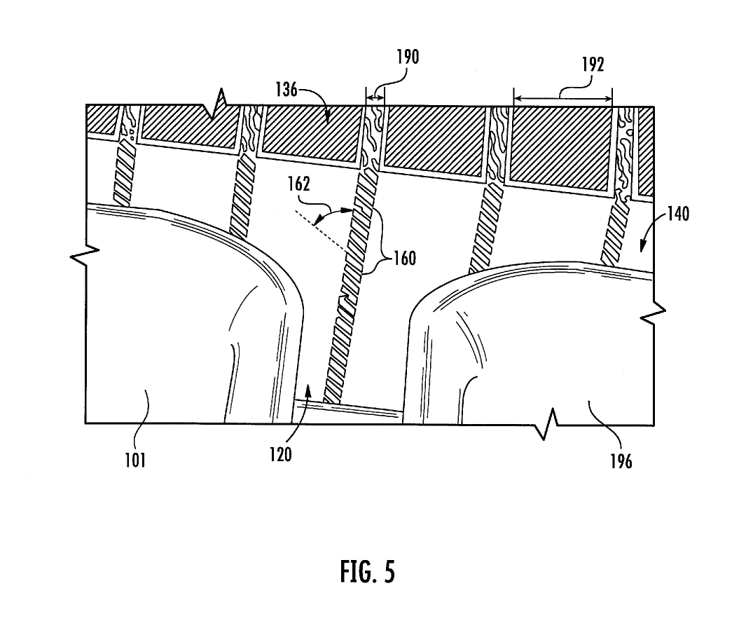

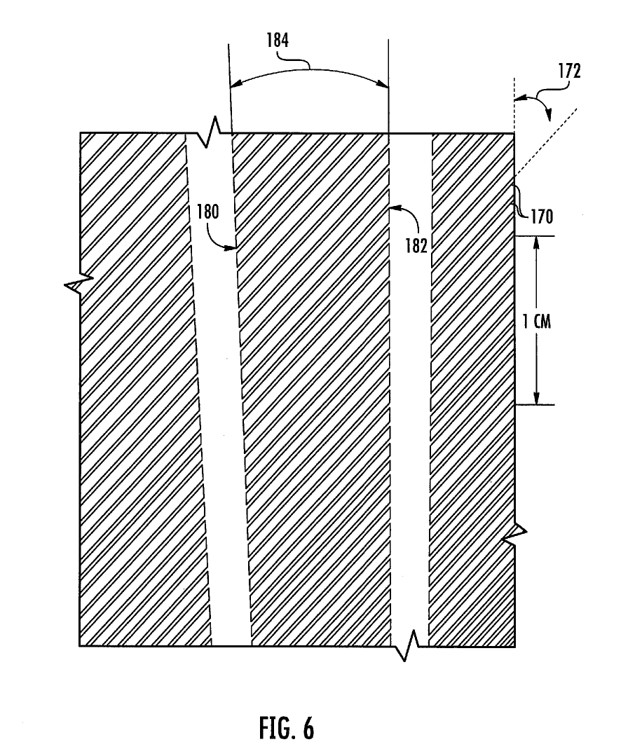

Throughout, not all of the heat exchanger features are shown for clarity of illustration. However, referring now to FIGS. 4 through 6, various fluid passageways and the associated heat exchanger features are described. FIG. 4 provides a side, cross-sectional view of the heat exchanger illustrating the first fluid passageways. FIG. 5 provides a close-up, perspective view of the cross-section illustrated in FIG. 3. FIG. 6 provides a close-up view of the plurality of second fluid passageways.

The plurality of the first fluid passageways may include a first plurality of heat exchanger features. The heat exchanger features are illustrated in this embodiment as slats or fins 160. These slats or fins may increase surface area to enhance the transfer of thermal energy. The fins in other embodiments to be linear or curved, and oriented at an angle relative to a plane defined by a wall of the fluid passageway. As shown in FIG. 5, the fins may be oriented at a first angle 162 relative to the walls of the plurality of the first fluid passageways. For example, first angle may be between about ten and eighty degrees, between about thirty degrees and sixty degrees, or about forty-five degrees according to some embodiments. The angle may change over the length of the of an elongated heat exchanger feature to impart a twist or helix. In this manner, the heat transfer surface of each fin may be relatively increased. Unless stated otherwise, a slat extends across a passageway and connects at both ends, whereas a fin connects at one end and is unattached at the other. Reference to heat exchanger features, fins, slats, protuberances, whiskers, and the like are interchangeable unless context or language indicates otherwise.

Referring again to FIG. 4, according to the illustrated embodiment, the fins are staggered. Staggering the fins may increase fluid contact with the fins. As used herein, a fluid passageway with “offset” or “staggered” heat exchanger features is one where features adjacent to each other along the first or second fluid flow direction are offset from each other along a direction perpendicular to the first or second fluid flow direction. Notably, the magnitude of the offset and the spacing of the fins along the first fluid flow direction may vary while remaining within the scope of the subject matter. In addition, or alternatively, the fins may be similarly staggered in second fluid passageways. The first fluid passageway defines a first fluid flow direction and second fluid passageway defines a second fluid flow direction.

Referring now specifically to FIG. 6, a close-up view of the plurality of second fluid passageways is illustrated. Similar to the plurality of the first fluid passageways, the second fluid passageways may include a plurality of heat exchanging surfaces, e.g., fins, for enhancing heat transfer. Other fins may be oriented at any suitable angle relative to a wall of the fluid passageway. For example, as illustrated, fins 170 are oriented at a second angle 172 relative to the walls of the plurality of second fluid passageways. For example, the second angle may be between about ten and eighty degrees, between about thirty degrees and sixty degrees, or about forty-five degrees according to some embodiments. In this manner, the heat transfer surface of each of the fins may be increased.

One or more of the plurality of second fluid passageways may be fan-shaped, or may have an increasing width toward the bottom side of the heat exchanger to provide an overall curved profile to the heat exchanger. A curved profile may aid, for example, to follow the contour of an engine to which the heat exchanger may be mounted. The plurality of second fluid passageways may be defined in part by a first wall 180 and a second wall 182. A third angle 184 may be defined between first wall and second wall. The third angle may be relatively small, e.g., less than five degrees, or large, e.g., greater than forty degrees depending on the location in the core and other application specific parameters.

The additive manufacturing methods disclosed herein allow for the integral manufacture of very thin fins inside of a monolithic core. For example, the fins may each have a thickness in a range of from about 0.01 cm to about 0.2 cm. In other embodiments, the fins may have a thickness in a range of from about 0.2 cm to about 0.5 cm. The fins may be manufactured at a suitable fin thickness down to a single additively constructed layer, e.g., ten micrometers. The ability to manufacture extremely thin fins, slats or other protuberances may enable the manufacture of a heat exchanger with a very large density of heat exchanger features. For example, the fins may be formed to have a fin density between about two and thirteen fins per centimeter. The fins may have a fin density of ten or more fins per centimeter. However, according to alternative embodiments, the fin density of the fins may be greater than twelve heat exchanger features per centimeter. Moreover, each of the fins may be identical and evenly spaced throughout each fluid passageway or each fin may be different and spaced in a non-uniform manner.

The first fluid passageways and second fluid passageways define non-circular geometries. The geometries may be selected so as to increase the surface area available for thermal exchange. For example, the first fluid passageways and second fluid passageways may have square or rectangular cross-sectional profiles. In this regard, each fluid passageway may have a height that is, for example, an average distance measured perpendicular to the flow of fluid within the passageway. For example, the passageway height may be the average distance between the walls of the respective fluid passageway, e.g., from one passageway wall to the other along a direction perpendicular to the walls.

According to the embodiment shown in FIG. 5, each of the first fluid passageways define a first passageway height 190 and each second fluid passageway define a second passageway height 192. The first passageway height and the second passageway height may be the distance between first wall 180 and second wall 182 for a given fluid passageway. The first passageway height and second passageway height may be uniform along a length of the respective passageway or may vary along a length of the passageway as illustrated in FIG. 6. In addition, each passageway within an array of passageways may have a similar or different height.

The first passageway height and second passageway height may be selected to improve the flow of a fluid passing through the respective passageway. For example, a height of a fluid passageway passing oil therethrough may be smaller than a height of a fluid passageway passing air. According to one embodiment, at least one of the first passageway height and second passageway height is between about 0.0254 cm and 2.54 cm. The first fluid passageways and second fluid passageways may have a size and geometry based on application specific parameters.

Each of the first fluid passageway and second fluid passageway may be straight, curvilinear, serpentine, helical, sinusoidal, or any other suitable shape. For example, as illustrated in FIG. 4, first fluid passageway is curvilinear, i.e., bowed or U-shaped. The heat exchanger may include performance-enhancing geometries and heat exchanger features whose practical implementations are facilitated by an additive manufacturing process, as described below. According to some embodiments, the first fluid passageway and second fluid passageway may have a plurality of heat exchanges surfaces or features, e.g., fins, to assist with the heat transfer process.

Portions of the heat exchanger may be constructed using a suitable material, in a suitable geometry, density, and thickness, as needed to provide necessary structural support to the heat exchanger during a particular operation. For example, external walls 196 of the heat exchanger may be formed from a rigid, thermally insulating material. In addition, suitable external walls may be thicker and denser to provide structural support for loads experienced by the heat exchanger during mounting, assembly, and operation of a gas turbine engine. By contrast, internal walls (e.g., walls 180 and 182 of the second fluid passageways) may be thinner and constructed of a more thermally conductive material in order to enhance heat transfer. For example, according to one embodiment, walls of the heat exchange passageways may be constructed of a thermally conductive metal alloy and may be less than 0.07 cm thick. According to still another embodiment, walls of heat exchange passageways may be about 0.03 cm thick and may selected based at least in part on the operating pressure and temperature, and on what fluid will be passed through the passageway.

According to the illustrated embodiment, the first fluid passageways and second fluid passageways have a cross-flow configuration, i.e., the oil and air flow perpendicular to each other. In another embodiment, the first fluid passageways and second fluid passageways operate as a counter-flow setup, where the heat exchanger is designed such that the first fluid passageways and second fluid passageways are substantially parallel and the respective fluid streams travel in opposite directions in their respective passageways. In addition, according to some embodiments, the fluids may travel in the same direction in their respective passageways.

Available additive manufacturing methods may enable the formation of heat exchangers having a defined size or shape. The footprints or external profiles of the heat exchangers may be square, circular, curvilinear, or any other suitable shape, e.g., to fit snugly into otherwise “lost space” in an engine, or to be more aerodynamic or efficient. In addition, the fluid supply passageways within the heat exchanger may be of an application specific size or configuration and may include defined profiles, thinner walls, smaller passageway heights, and more complex and intricate heat exchanger features.

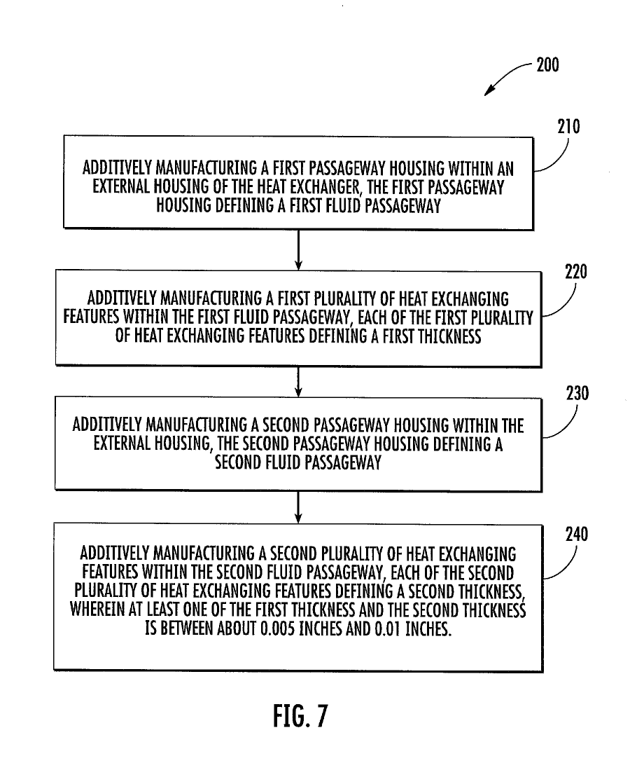

A method 200 for forming a monolithic heat exchanger according to one embodiment of the subject matter is provided. The method can be used to form the heat exchanger. Referring now to FIG. 7, the method includes, at step 210, additively manufacturing a first passageway housing within an external housing of the heat exchanger, the first passageway housing defines a first fluid passageway. Step 220 includes additively manufacturing a first plurality of heat exchanger features within the first fluid passageway, each of the first plurality of heat exchanger features defining a first thickness. Step 230 includes additively manufacturing a second passageway housing within the external housing, the second passageway housing defining a second fluid passageway. Step 240 includes additively manufacturing a second plurality of heat exchanger features within the second fluid passageway, with each one of the second plurality of heat exchanger features having a different, second thickness. At least one of the first thickness and the second thickness may be in a range of less than about 0.03 cm. And, as noted in this disclosure, the thicknesses may differ from each other in thickness, shape, orientation relative to the substrate, and material composition. Further, the differences may be based on which passageway they are disposed in or along the length of one of the passageways (or both).

In one embodiment, heat exchanging device may include a tube-shell precooling stage with one or more thermally-compliant features and a plate-fin design. This configuration may provide for extended effectiveness and compactness. The compliant feature may expand/contract, bend or flex under load to avoid breaking. Components with different coefficients of thermal expansion, or that have different temperature profiles, may cause thermal stress in and between different segments of a thermal management system. Compliant features may be used to relieve at least some of the thermally induced stress.

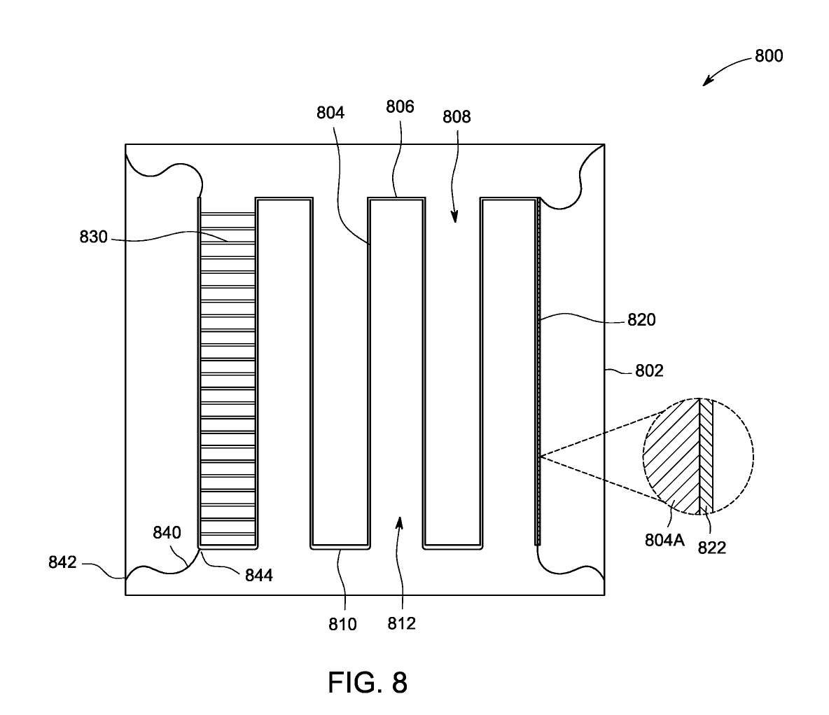

With reference to FIG. 8, a thermal management system 800 is illustrated that includes a housing 802 according to an embodiment of the invention. The system includes a monolithic core structure 804 disposed within the housing. An outer surface 806 of the core structure defines at least part of a first passageway 808. An inner surface 810 of the core structure defines at least part of a second passageway 812. The core structure includes a separator wall 820 that isolates a first flow (not shown) passing through the first passageway from a second flow (not shown) passing through the second passageway. An expanded cross-sectional view of the separator wall illustrates the separator core 804A wall and a coating 822 disposed on the outer surface. The coating is shown over only a portion of the outer surface in the illustrated embodiment. In the illustrated embodiment, the core structure is steel, and the coating is a non-fouling, anti-corrosive nitride finishing layer.

The first passageway is in thermal communication with the second passageway. The core structure includes one or more heat exchanger features 830, that are positioned within the first passageway. No heat exchanger features are shown in the second passageway to avoid cluttering the depiction. The illustrated heat exchanger features are linear slats that extend perpendicularly across the first passageway to increase the heat transfer surface area. The heat exchanger features have a thickness that is about the same as the thickness of the core structure wall; and have a distribution density expressed as a ratio of 4 to 1, with there being four heat exchanger features disposed along a length that is the same as the width of the passageway. Not shown is the profile of the heat exchanger feature that is an elongate teardrop, and that the heat exchanger features are staggered relative to an adjacent heat exchanger feature. The configuration of the heat exchanger features may be selected to hold the fluid flow against its surface to minimize laminar flow properties and increase impingement of the passing fluid by exacerbating the creation of a turbulent boundary layer. In one embodiment, the profile is configured relative to a surface of the core to create the Coanda effect along at least a portion of the length of one or more of the heat exchanger features.

Referring again to FIG. 8, the core structure further has a compliant segment 840 having a first end 842 coupled to the housing structure at a first end 842, and a second end 844 coupled to the separator wall. In another embodiment, the compliant segment couples one separator wall to another separator wall. As shown, one or more compliant segments may be included in the system. These compliant systems may have a mode where they are curved or coiled, and another mode in which they are stretched or linear. The compliant segment may thus have, depending on the mode, one or more curves or bends. These bends may form an “S” shape or an accordion shape, for example. The illustrated embodiment shows simple curves, and is formed from a material that is different from, and more flexible than, the core structure. The heat exchanger features of the core structure may be selected for one or more of high thermal conductivity, erosion resistance, corrosion resistance, chemical resistance, or fouling resistance. In alternative embodiments, the materials may be the same but the thicknesses may differ.

The disclosed the thermal management systems may be manufactured or formed using a suitable process. However, in accordance with several aspects of the disclosed subject matter, the heat exchanger may be formed using an additive-manufacturing process, such as a 3-D printing process. The use of such a process may allow the heat exchanger to be formed integrally, as a single monolithic component, as described above according to one embodiment. The manufacturing process may allow the heat exchanger to be integrally formed and include a variety of features not possible when using other manufacturing methods.

As used herein, the terms “additively manufactured” or “additive manufacturing techniques or processes” refer generally to manufacturing processes wherein successive layers of material(s) are provided on each other to “build-up”, layer-by-layer, a three-dimensional component. The successive layers generally fuse together to form a monolithic component which may have a variety of integral sub-components. By contrast, multiple cast or formed parts that are welded together are not monolithic.

Suitable additive manufacturing techniques in accordance with the disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Metal Laser Sintering (DMLS), and other processes selected based on application specific parameters and requirements.

The additive manufacturing processes described herein may form components using a material suitable for the end use application. Depending on the use of the component, the material may be plastic, metal, concrete, ceramic, cermet, polymer, epoxy, photopolymer resin, or another material. The starting material may be in solid, liquid, powder, sheet material, wire, or another form. In one embodiment, the heat exchanger may be formed in part, in whole, or in a combination of materials. In one embodiment, this combination may include multiple metals and their alloys. Suitable metals may include aluminum, beryllium, copper, iron, magnesium, nickel, rhenium, tin, and titanium. Suitable alloys may include alloys of the foregoing, including nickel alloys, chrome alloys, titanium alloys, magnesium alloys, aluminum alloys, and austenite alloys. Suitable austenite alloys may include nickel-chromium-based superalloys (e.g., those available under the name Inconel® available from Special Metals Corporation) and cobalt chrome alloys.

In addition, a variety of materials and methods for bonding those materials may be used and are contemplated as within the scope of the disclosure. As used herein, references to “fusing” may refer to a process for creating a bonded layer based on application specific requirements. For example, if an object is made from polymer, fusing may refer to creating a thermoset bond between polymer materials. If the object is epoxy, the bond may be formed by a crosslinking process. If the material is ceramic or cermet, the bond may be formed by a sintering process. If the material is powdered metal, the bond may be formed by a melting process. Other methods of fusing materials to make a component by additive manufacturing may be employed.

In one embodiment, the additive manufacturing process disclosed herein allows a single component to be formed from multiple materials. That is, the heat exchanger may be formed from a suitable mixture of the above materials and/or formed from different materials in different portions or segments. For example, a component may include multiple layers, segments, or parts that are formed using different materials, processes, and/or on different additive manufacturing machines and still forming a monolithic part. In this manner, components may be constructed which have different materials and material properties for meeting the parameters of a particular application.

In this application, there may be a transition portion between portions of different material. Alternatively, there may be a clear boundary layer between the two (or more) materials. By using a transition portion it may be able to affect component performance. For example, materials with differing coefficients of thermal expansion (CTE) may have a gradient of concentration that transitions from 100% concentration of one material to 100% concentration of the other material with the concentration at the middle of the transition portion being about 50% of each. Depending on the application requirements and the material properties, different gradient change rates, and the uniformity of that gradient along a transition portion, may be used. Other factors, besides thermal expansion, may be taken into consideration. These other factors may include cost out (using cheaper material where the more expensive is not necessary), strengthening (using stronger materials where a boost in strength is needed), and the like.

Bimetallic combinations may be created. In such an application, differences in material characteristics may be useful. Referring again to the CTE example, by layering two materials with different CTE next to each other, they may expand or contract by different amounts as a function of temperature change. Accordingly, in one embodiment, a heat exchanger may have heat exchanger features, such as fins or whiskers, made using a bimetallic layering processes so that as the temperature of the fin changes the physical configuration of the fin also changes. This may be used to selectively direct a flow of fluid passing the fin based on a temperature of the fluid. It may be used to increase or decrease a flow rate through the heat exchanger (again, based on temperature of the contacting fluid). Further, the fins in one passageway may differ from the fins of another passageway (with a different fluid). For example, as an exhaust gas flow temperature increases, fins may retract to reduce the thermal transfer rate on the “hot side”; at the same time, fins in contact with the coolant may extend to increase the surface area or impingement and thereby disperse the thermal load to the coolant more efficiently. Thus, the thermal mass transfer in hot spots may rebalance to cooler spots, and that is relatively more uniform heat transfer from exhaust gas to coolant than if static fins were present in one or both of the two flow paths or passageways that are exemplified.

A coating or coating layer may be created along surfaces that contact fluid flows through one or more passageway. Suitable coatings may be of a different material than the supporting or base structure of the monolith, but are still formed as a single structure (and so are part of the monolith). The coating layer may be used to separate the fluid from the base structure, in one embodiment. Thus, a base structure of aluminum may be susceptible to chemical dissolution if contacted with a basic or acidic fluid, and so a chemically inert coating may be created to prevent contact of the aluminum with the acid/base fluid. In one embodiment, a catalyst material (e.g., platinum) may be included in the coating so that a flow of exhaust gas may be catalyzed as it passes over the coating. In another embodiment, the coating may have low surface energy and/or a smooth surface (i.e., a surface roughness below a threshold value) so as to, for example, reduce or control a pressure drop of a flow through the heat exchanger.

Similar to the coating, a post processing surface finishing step may be performed on the heat exchanger. Suitable mechanical post processing depends on application specific parameters, however in some embodiments a slurry wash may be used. Other suitable processes may include honing, lapping, superfinishing, to change the surface texture or roughness. It may be useful to post process by chemically altering the surface, such as through acid wash, nitriding, carburizing, boriding, carbonitriding, and ferritic nitrocarburizing. In one embodiment, the creation of the additively manufactured feature may include a material that, in post process, is converted to another material. Examples of this may include a calcine or ceramic/glaze that form by heating the heat exchanger to a temperature sufficient to initiate the conversion process.

Although a heat exchanger may be described as being constructed entirely by additive manufacturing processes, in at least one embodiment, a portion of the heat exchanger may be formed otherwise, e.g., via casting, machining, and/or a suitable manufacturing process. The non-additive manufactured part may then be combined with the monolithic additive portion, which may be “built on” the base portion. An over-molded plastic part is a poor but effective example of two manufacturing processes being combined to create a single article of manufacture. That is, a cast portion may be combined with an additive portion that may be built onto it. That additive portion may encapsulate the cast portion or only couple to a side of the cast portion.

One additive manufacturing process will now be described. Additive manufacturing processes fabricate components using three-dimensional (3D) information, for example a three-dimensional computer model, of the component. Accordingly, a three-dimensional design model of the heat exchanger may be defined prior to manufacturing. In this regard, a model or prototype of the heat exchanger may be scanned to determine the three-dimensional information of the heat exchanger. As another example, a model of the heat exchanger may be constructed using a suitable computer aided design (CAD) program to define the three-dimensional design model of the heat exchanger.

Each successive layer may be, for example, in a range of from about 10 micrometers (μm) to about 200 μm, although the thickness may be selected based on application specific parameters and may be sized based on the application. Therefore, utilizing the additive formation methods described above, the heat exchanging surfaces (e.g., walls) may be as thin as one thickness of an associated powder layer, e.g., 10 μm, utilized during the additive formation process.

The heat exchanger may be a monolithic or single piece of continuous material. By “monolithic” it is meant that they may include no or fewer components and/or joints relative to existing heat exchangers. Monolithic expressly excludes molded, casting or cast parts. The integral formation of the heat exchanger through additive manufacturing may improve the overall assembly process. For example, the integral formation may reduce the number of separate parts to be assembled, thus reducing associated time and assembly costs. Additionally, existing issues with, for example, leakage, welding, and joint quality between separate parts, and overall performance may be reduced.

The additive manufacturing methods described enable more complex and intricate shapes and contours of the heat exchanger. For example, the heat exchanger may include thin walls (less than 0.07 cm), narrow passageways, and heat exchanger features. These features may be relatively complex and intricate for maximizing heat transfer and minimizing the size or footprint of the heat exchanger. The additive manufacturing process enables the manufacture of structures having different materials, specific heat transfer coefficients, or desired surface textures, e.g., that enhance or restrict fluid flow through a passageway. The successive, additive nature of the manufacturing process enables the construction of these passages and features. As a result, the heat exchanger performance may differ relative to other heat exchangers.

Utilizing an additive process, the surface finish and passageway size may be formed to improve fluid flow through the passageways, to improve heat transfer within the passageways, etc. For example, the surface finish may be adjusted (e.g., made smoother or rougher) by selecting appropriate laser parameters during the additive process. A rougher finish may be achieved by increasing laser scan speed or a thickness of the powder layer, and a smoother finish may be achieved by decreasing laser scan speed or the thickness of the powder layer. The scanning pattern and/or laser power can also be changed to change the surface finish in a selected area. Notably, a smoother surface may promote a faster flow of fluid through a heat exchanger passageway, while a rougher surface may promote turbulent flow of fluid and increased heat transfer.

In one embodiment of the invention, a thermal management system includes a housing. The system includes a monolithic core structure disposed within the housing. An outer surface of the core structure defines at least part of a first passageway. An inner surface of the core structure defines at least part of a second passageway. The core structure includes a separator wall that isolates a first flow passing through the first passageway from a second flow passing through the second passageway. The first passageway may be in thermal communication with the second passageway. The core structure includes one or more heat exchanger features, or fins, that are positioned within the first passageway, the second passageway, or both the first and second passageways. The heat exchanger features have a thickness and a distribution density. And, the core structure further has a compliant segment having a first end coupled to the housing structure and a second end coupled to the separator wall. In another embodiment, the compliant segment couples one separator wall to another separator wall. The compliant segment does not travel along the entire length of the passage way and only couples the aforementioned separator walls or housing.

In one embodiment, the compliant segment can take on different forms. Each form may be better suited in different applications based on a number of criteria that could include among many others, the material used, the length of the segment, the thermal and physical stresses on the segment, or perhaps the fluid flowing in contact with the thermal segment. In one embodiment, the compliant segment may be non-linear and allows for flexion, expansion, or both of the core structure relative to the housing

In one embodiment, a thermal management system may include two or more different materials. These materials could be non-homogenous and unalloyed with each other. This could take on many different forms. Some examples of those forms follow but the possible embodiments are not limited to just those listed here. The different materials could be layered upon one another, alternating material in a pattern or at random. The material could be used to coat surfaces of the heat exchanger. The material could be the material added in a chemical or electrochemical process like anodization or similar process. The materials could be mixed throughout forming regions of different materials. These regions could range in size from smaller than a grain of sand, to as large as the thermal management system itself. One example of this could be created by mixing the powder of different materials to be used in creating the thermal management unit should it be additively manufactured.

In one embodiment, a thermal management system can use two or more different materials. These materials are used so that a first material may be in a first portion and a second material may be in a second portion of the heat exchanger housing. These portions could be designed such that a material with higher fatigue could be used in regions or portion that experience higher physical stresses, while a more readily available material could be used for less critical regions or portions. The materials selected for the different portions could also be used to balance local thermal effectivity. The material selected for one portion could have a much higher thermal conductivity and the material selected for another portion could have a much lower thermal conductivity. This could be done to reduce local effectivity in areas of high thermal stress relative to other areas of the thermal management system, thus evening out the amount of heat transfer along the path of the fluid flow.

In one embodiment, the portions could be layered in a thermal management system with multiple materials in multiple portions. The first portion and the second portion could be different layers of a heat exchanger feature. The first material could have a coefficient of thermal expansion that differs from the coefficient of thermal expansion of the second material. Additionally, the heat exchanger features could change as a function of the temperature of the heat exchanger feature. The heat exchanger features could be wavy or take on a non-planer shape. The materials used in the heat exchanger features could both be different materials than any of the other materials used in the thermal management unit. The heat exchanger features could also form a part of the wall separating fluid flow. In this embodiment, the feature could redirect the flow to different channels based on the temperature of the fluids. In another embodiment, the heat exchanger features could be fins, and the fins could adjust to be staggered or non-staggered based on the temperature of the fluid. Additionally, the thermally adjusting heat exchanger features may or may not be present in the entire thermal management system. Also, the features may or may not behave in the same manner throughout the system.

In one embodiment of a thermal management system, there may be a first and second portion. The first portion may be a first stage and the second portion may be a second stage of the housing. The first flow or second flow may pass through the first portion first, and then the second portion second. At least some of the stages may not be made from the same material. Higher fatigue or lower thermal conductivity materials could be used in the stage with the highest thermal gradient between fluid flow, and more radially available or higher conductivity material could be used in stages with lower thermal gradient between flows.

In one embodiment, the separator wall of the thermal management system defines one or more paths. These paths constitute a single passageway. At least two of the paths may not be non-parallel to each other. A series of paths may be non-parallel to one another causing the overall shape of the thermal management system to be curvilinear and/or tortuous.

The system may define two or more passageways. In one embodiment, there is a first passageway and second passageway. The first passageway, the second passageway, or both may differ in one or more ways from each other. One difference may be in cross-sectional area along the path of their respective flows. The cross-sectional area of the passageway may differ based at least in part on application specific parameters. Those parameters may include the fluid type, the flow rates, the heat transfer rates, the wall thickness, the wall or heat exchanger materials, or fin material.

With regard to the cross-sectional area, there is a first and second thickness depending on the location. At least one of these thicknesses may in a range of from about 0.0127 cm to about 0.0254 cm. The thickness range appropriate may be based at least in part on the specific application. Suitable ranges appropriate for particular uses may be from about 0.0127 cm to about 0.0150 cm, from about 0.0150 cm to about 0.0170 cm, from about 0.0170 cm to about 0.0190 cm, from about 0.0190 cm to about 0.0210 cm, from about 0.0210 cm to about 0.0230 cm, or form about 0.0230 cm to about 0.0254 cm. Considerations in selecting the appropriate range may include the pressure drop allowed through the thermal management system, the properties of the fluid or fluids flowing through the system, the desired surface area of the system, the material of the fins, the orientation of the fins, the desired thermal effectivity, or the material of the walls of the system. These thicknesses describe the thicknesses of the heat exchanger features. These features could take on many different forms and among others could be protuberances, hairy/whiskers, or elongate fin-like structures.

In one embodiment, there may be a first heat exchanger feature density and a second heat exchanger feature density. At least one of these densities may differ along at least one of the passageways throughout the thermal management system. In some instances, based on application, the density may differ discreetly in one or more stages, in other instances the density may differ gradually throughout at least a portion of the passageway, or both may occur along the same passageway. The distribution density could be in a range of from about two features per centimeter to about fourteen heat exchanger features per centimeter. This range can be divided into many different sub-ranges depending on the application of the thermal management unit. The distribution density range most appropriate or the manner in which the density differs may depend at least in part on one or more of the feature's material, the particular fluid used, the feature thickness, the configuration or shape of the features, the overall effectivity requirement, the localized effectivity requirement or the allowable pressure drop of the fluid through the system. Other aspects may differ along the passageway. For example, the fins themselves may change, the angle of the fins relative to the wall may change, and the feature density may change all as a function of one another. The fins may have a different density, spacing, or orientation as a function of location along the flow path.

The distribution density of the heat exchanger features may be relatively lower in a portion of the heat exchanger with a relatively higher level of thermal stress. Conversely, the distribution density of the heat exchanger features may be higher in a portion that has less thermal stress. Thermal stress may be one or more of thermal cycling, absolute temperature swings, thermal excursions beyond a determined operational temperature range, or a combination of the foregoing coupled with higher pressure differentials and/or vibrations.

In one embodiment, at least one heat exchanger feature or fin may not be perpendicular to the wall. At least one of the heat exchanger features may be oriented at an angle relative to a plane defined by the wall that falls within many different ranges. A suitable range for the angle may be from about 0.001 degree to less than 90 degrees. Depending on the application, the angle may be in a range of from about 0.001 degrees to about 15 degrees, from about 16 degrees to about 30 degrees, from about 31 degrees to about 45 degrees, from about 46 degrees to about 60 degrees, from about 61 degrees to about 75 degrees, or from about 76 degrees to less than 90 degrees. The particular angle may depend at least in part on the application and other contributory factors. Some of these factors may include the types of thermal fluid used in the various passageways of the device, the thickness of the heat exchanger features, the density of the heat exchanger features, the allowable pressure drop through the thermal management unit, the overall required effectivity of the thermal management system, or the local required effectivity of the thermal management system, and the materials used in forming the heat exchanger features.

Multiple heat exchanger features may be used. Following a direction of flow through the passageway, there may be a first heat exchanger feature offset relative to a second heat exchanger feature located downstream the flow to the first feature. In this manner, the features can be staggered thereby breaking up the boundary layer of the flow against the wall and increasing the number of impingement points.

In one embodiment, one or more of the heat exchanger features may have a complex shape. A heat exchanger feature with a complex shape may be a fin with non-planner shape. A suitable fin may be curved, wavy, or rugate/accordion shaped. It may attach to at least two walls that separate a fluid flow.

In one embodiment, the housing defines a first inlet region and a first outlet region. Both regions are on opposite ends of the first passageway. The first inlet may be upstream of the first outlet region relative to the flow. The flow has a higher temperature at the first inlet region than at the first outlet region. The heat exchanger feature density may be lower in the first inlet region than in the first outlet region. The housing may define a second inlet region and a second outlet region on opposite ends of the second passageway. The second inlet region may be upstream of the second outlet region relative to the second flow. The second passageway may have a higher volumetric flow rate, a higher linear flow velocity, or both depending on the application in the first inlet region than in the first outlet region.

In one embodiment, the housing may define a sensor port. This port would receive a sensor, or a plug when the sensor is not present. A housing may include at least a portion of an exhaust gas recirculation system, oil cooler system, radiator system or fuel heater system, intercooler system, or aftercooler system that may be coupled to an engine.

In one embodiment, the thermal management system includes a housing. The housing includes a monolithic core structure within the housing. There may be an outer surface of the core structure defining at least part of a first passageway and an inner surface of the core structure defining at least part of a second passageway. The core structure includes a separator wall that isolates a first flow passing through the first passageway from a second flow passing through the second passageway. The first passageway may be in thermal communication with the second passageway. The core structure includes one or more heat exchanger features that are positioned within the first passageway, the second passageway, or both the first and second passageway. The heat exchanger features have a thickness and a distribution density. Also, the core structure comprises two or more different materials that are non-homogeneous and unalloyed with each other.

In one embodiment, the thermal management system includes a housing. The housing includes a monolithic core structure within the housing. There may be an outer surface of the core structure defining at least part of a first passageway and an inner surface of the core structure defining at least part of a second passageway. The core structure includes a separator wall that isolates a first flow passing through the first passageway from a second flow passing through the second passageway. The first passageway may be in thermal communication with the second passageway. The monolithic core structure includes one or more fins that are positioned within the first passageway, the second passageway, or both the first and second passageway. The fins have a complex shape. The monolithic core structure includes a coating or surface layer that may be a different material than a base portion of the core structure, the one or more fins, or both the core structure and the fins.

Reference may be made in detail to embodiments of the invention, one or more examples of which are illustrated in the accompanying drawings. The detailed description uses numerical and letter designations to refer to features in the drawings. Like or similar designations in the drawings and description have been used to refer to like or similar parts.

As used herein, the terms “first”, “second”, and “third” may be used interchangeably to distinguish one component from another and are not intended to signify location or importance of the individual components. The terms “upstream” and “downstream” refer to the relative direction with respect to fluid flow in a fluid pathway. For example, “upstream” refers to the direction from which the fluid flows, and “downstream” refers to the direction to which the fluid flows. As used herein, a “fluid” may be a gas or a liquid. A suitable cooling fluid may be air, and the cooled fluid may be lubricating oil. Other types of fluids, liquid and gaseous, may be used. Other examples of the fluids may include kerosene, gasoline or diesel fuel. Yet other fluids may be hydraulic fluid, combustion gas, refrigerant, refrigerant mixtures, dielectric fluid for cooling electronic systems, water or water-based compounds, antifreeze additives (e.g., alcohol or glycol compounds), and other organic or inorganic heat transfer fluid or fluid blends. In some applications, these fluids are capable of persistent heat transport at elevated or reduced temperatures.

This written description uses examples to disclose the invention, including the best mode, and also to enable a person of ordinary skill in the art to practice the invention, including making and using any devices or systems and performing any incorporated methods. The patentable scope of the invention is defined by the claims, and may include other examples that occur to those of ordinary skill in the art. Such other examples are intended to be within the scope of the claims if they include structural elements that do not differ from the literal language of the claims, or if they include equivalent structural elements with insubstantial differences from the literal languages of the claims.

What is claimed is:

1. A thermal management system comprising:
a housing;
a monolithic core structure disposed within the housing, and an outer surface of the core structure defining at least part of a first passageway, and an inner surface of the core structure defining at least part of a second passageway, and the core structure includes a separator wall configured to isolate a first flow passing through the first passageway from a second flow passing through the second passageway, and the first passageway is in thermal communication with the second passageway, and
the core structure including one or more heat exchanger features that are positioned within the first passageway, the second passageway, or both the first and second passageway, and the heat exchanger features have a thickness and a distribution density, and
the core structure further having a compliant segment having a first end coupled to the housing structure and a second end coupled to the separator wall, or the compliant segment couples one separator wall to another separator wall.

2. The thermal management system of claim 1, wherein the compliant segment is non-linear and allows for flexion, for expansion, or both flexion and expansion of the core structure relative to the housing.

3. The thermal management system of claim 1, wherein the housing comprises two or more different materials that are non-homogeneous and unalloyed with each other.

4. The thermal management system of claim 3, wherein the two or more different materials are disposed so that a first material is in a first portion and a second material is disposed in a second portion of the housing.

5. The thermal management system of claim 4, wherein the first portion and the second portion are different layers of a heat exchanger feature, and the first material has a coefficient of thermal expansion that differs from the coefficient of thermal expansion of the second material, and whereby the shape of the heat exchanger feature changes as a function of a temperature of the heat exchanger feature.

6. The thermal management system of claim 1, wherein the first portion is a first stage and the second portion is a second stage of the housing so that the first flow or the second flow passes through the first portion prior to passing through the second portion.

7. The thermal management system of claim 1, wherein the separator wall defines a plurality of paths that constitute a single passageway and at least two of the paths are oriented and configured to be non-parallel to each other.

8. The thermal management system of claim 1, wherein the first passageway, the second passageway, or both the first and second passageways differ in cross-sectional area along the path of their respective flow.

9. The thermal management system of claim 1, wherein at least one of the first thickness and the second thickness is in a range of from about 0.0127 cm to about 0.0254 cm.

10. The thermal management system of claim 1, wherein at least one of the first heat exchanger feature density and the second heat exchanger feature density differ along at least one passageway throughout the thermal management system.

11. The thermal management system of claim 1, wherein the distribution density of the heat exchanger features is lowest in the portion of the heat exchanger that has relatively more thermal stress than a portion that has less thermal stress.

12. The thermal management system of claim 1, wherein at least one of the heat exchanger features is oriented at an angle relative to a plane define by the wall that is in a range of from about 0.001 degree to less than 90 degrees.

13. The thermal management system of claim 1, wherein the heat exchanger feature is one of a plurality of heat exchanger features, and in a direction of flow through the passageway a first one of the plurality of heat exchanger features is offset relative to a second heat exchanger features located downstream in the flow of the first heat exchanger feature so as to stagger the heat exchanger features.

14. The thermal management system of claim 1, wherein at least one of the heat exchanger features has a complex shape.

15. The thermal management system of claim 1, wherein the housing further defines a first inlet region and first outlet region on opposite ends of the first passageway, with the first inlet region being disposed upstream of the first outlet region relative to the flow, and
the flow has at a higher temperature at the first inlet region than at the first outlet region, and
the heat exchanger feature density is lower in the first inlet region than in the first outlet region.

16. The thermal management system of claim 1, wherein at least one heat exchanger feature has a surface finish.

17. The thermal management system of claim 1, wherein the housing further defines a sensor port configured to receive a sensor.

18. The thermal management system of claim 1, wherein the housing comprises at least a portion of an exhaust gas recirculation system, oil cooler system, radiator system or fuel heater system, intercooler system, or aftercooler system that is coupled to an engine, and
the heat exchanger features are fins.

19. A thermal management system comprising:
a housing;
a monolithic core structure disposed within the housing, and an outer surface of the core structure defining at least part of a first passageway, and an inner surface of the core structure defining at least part of a second passageway, and the core structure includes a separator wall configured to isolate a first flow passing through the first passageway from a second flow passing through the second passageway, and the first passageway is in thermal communication with the second passageway, and
the core structure including one or more heat exchanger features that are positioned within the first passageway, the second passageway, or both the first and second passageway, and the heat exchanger features have a thickness and a distribution density, and
the core structure comprises two or more different materials that are non-homogeneous and unalloyed with each other.

20. A thermal management system comprising:
a housing;
a monolithic core structure disposed within the housing, and an outer surface of the core structure defining at least part of a first passageway, and an inner surface of the core structure defining at least part of a second passageway, and the core structure includes a separator wall configured to isolate a first flow passing through the first passageway from a second flow passing through the second passageway, and the first passageway is in thermal communication with the second passageway, and
the monolithic core structure including one or more fins that are positioned within the first passageway, the second passageway, or both the first and second passageway, and the fins have a complex shape, and
the monolithic core structure comprises a coating or surface layer that is a different material than a base portion of the core structure, the one or more fins, or both the core structure and the fins.
